(19) United States
(12) Patent Application Publication
(10) Pub. No.: US 2018/0130442 A1
(43) Pub. Date: May 10, 2018

(54) ANTI-SPY ELECTRIC DEVICE AND ADJUSTABLE FOCUS GLASSES AND ANTI-SPY METHOD FOR ELECTRIC DEVICE

(71) Applicants: Inventec (Pudong) Technology Corporation, Shanghai (CN); INVENTEC CORPORATION, Taipei City (TW)

(72) Inventor: Wen-Tung CHAN, TAIPEI CITY (TW)

(21) Appl. No.: 15/479,244

(22) Filed: Apr. 4, 2017

(30) Foreign Application Priority Data
Nov. 10, 2016 (CN) 201611037826.0

(51) Int. Cl. G09G 5/00; G09G 5/373; G02B 7/08

(52) U.S. Cl. CPC G09G 5/003; G09G 5/373; G09G 2340/045; G09G 2358/00; G09G 2370/04; G02B 7/08

(57) ABSTRACT

An anti-spy electric device includes a display device, a signal receiving unit, and a first image zooming unit. The display device is configured to display an image on a first image focal plane. The signal receiving unit is configured to receive an anti-spy start signal from a pair of adjustable focus glasses. The first age zooming unit is configured to transform the image displayed on the first image focal plane being displayed on a second image focal plane depending on the anti-spy start signal from the pair of adjustable focus glasses, and the first image focal place is not overlapping with the second image focal plane.

### RELATED APPLICATIONS

This application claims priority to Chinese Application Serial Number 201611037826.0, filed Nov. 10, 2016, which is herein incorporated by reference.

### BACKGROUND

### Technical Field

The present disclosure relates to an anti-spy electric device and a pair of adjustable focus glasses.

### Description of Related Art

In recent years, with the popularization of electronic devices (such as laptop computers, tablet computer, or smartphones), a software, hardware, and technology related to the electronic devices have been developed increasingly. Users can use the electronic devices for processing documents, trivia, and even financial transactions. However, when the user uses the electric device in public, contents displayed on the electric device may be susceptible to being spied by other people, such that the user's privacy may be invaded. Therefore, how to further improve a security of the contents displayed on the electric device to further protect the user's privacy has become an important research and development issue, and has an urgent need to be improved in the related fields.

In general, the user can mount an anti-spy filter to a display device of the electric device to prevent the contents on the display device from being spied. The anti-spy filter is configured to control light reflections, so other people at a field of view greater than a certain angle may not see the contents on the display device. For example, the people at a field of view greater than 60 degree may see a black image on the display device. However, the anti-spy filter may not prevent the people at a field of view less than the certain angle from spying the contents on the display device, so the anti-spy filter may not effectively improve the security of the contents displayed on the electric device.

### SUMMARY

The present disclosure relates to an anti-spy electric device and a pair of adjustable focus glasses, which combines the anti-spy electric device and the pair of adjustable focus glasses, so as to effectively prevent other people from spying, thereby improving a security of the contents displayed on the electric device.

In accordance with some embodiments of the present disclosure, an anti-spy electric device includes a display device, a signal receiving unit, and a first image zooming unit. The display device is configured to display an image on a first image focal plane. The signal receiving unit is configured to receive an anti-spy start signal from a pair of adjustable focus glasses. The first image zooming unit is configured to transform the image displayed on the first image focal plane being displayed on a second image focal plane depending on the anti-spy start signal from the pair of adjustable focus glasses, and the first image focal place is not overlapping with the second image focal plane.

In accordance with some embodiments of the present disclosure, a pair of adjustable focus glasses includes a group of lenses, an anti-spy start module, and a signal transmitting module. The group of lenses has a first lens focal plane. The anti-spy start module is configured to output an anti-spy start signal. The signal transmitting module is configured to transmit the anti-spy start signal to an anti-spy electric device. The first lens zooming unit, configured to transform the first lens focal plane of the group of lenses into a second lens focal plane depending on the anti-spy start signal, wherein the first lens focal plane is not overlapping with the second lens focal plane.

In accordance with some embodiments of the present disclosure, an anti-spy method for an electric device includes following steps. Displaying a image on a first image focal plane. Receiving an anti-spy start signal from an adjustable focus glasses. Transforming the image displayed on the first image focal being displayed on a second image focal plane depending on the anti-spy start signal from the pair of adjustable focus glasses, and the first image focal place is non-overlapping with the second image focal plane.

In one or more embodiments of this disclosure, by the anti-spy system (the pair of adjustable focus glasses and the anti-spy electric device), the image may be transformed from the first image focal plane I1 to the second image focal plane. In other words, a focal length of the image I may be varied, making the image I of the anti-spy electric device focus on the second image focal plane. At the same time, the first lens zooming unit of the pair of the adjustable focus glasses may make the image displayed on the second image focal plane be projected into a target positon (two eyes of the user). Therefore, the user wearing the pair of adjustable focus glasses may clearly observe the image. A viewer without the target positon may observe a blurred image, so as to improve the security of contents displayed on the anti-spy electric device, with the benefit of protecting the user's privacy.

It is to be understood that both the foregoing general description and the following detailed description are by examples, and are intended to provide further explanation of the invention as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a side view diagram of an anti-spy system for electric devices in applications in accordance with some embodiments of the present disclosure.

FIG. 2 is a diagram of an anti-spy system for electric devices in accordance with some embodiments of the present disclosure.

FIG. 3 is a flow chart of a anti-spy method for electric devices in accordance with some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

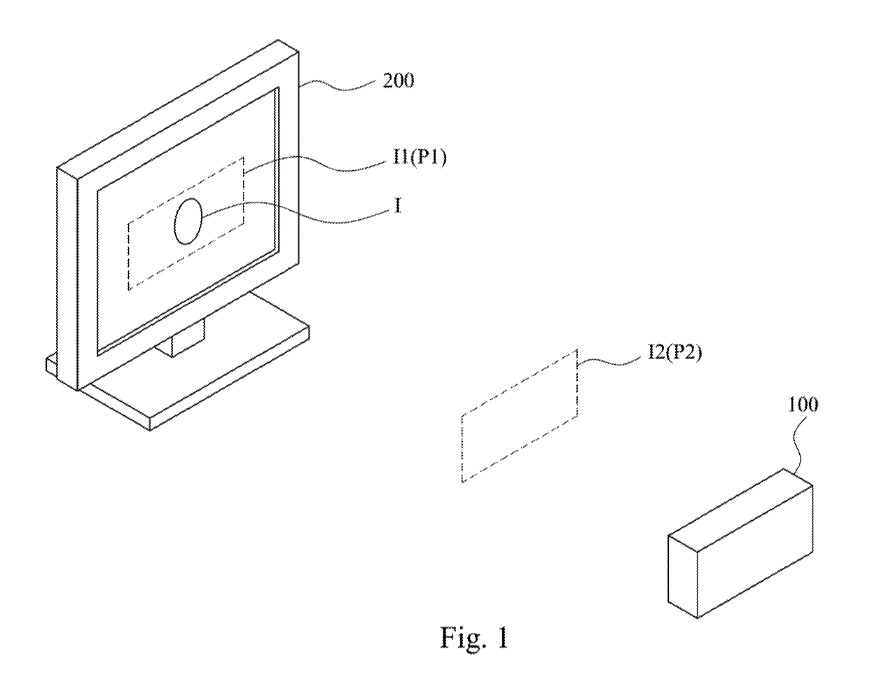

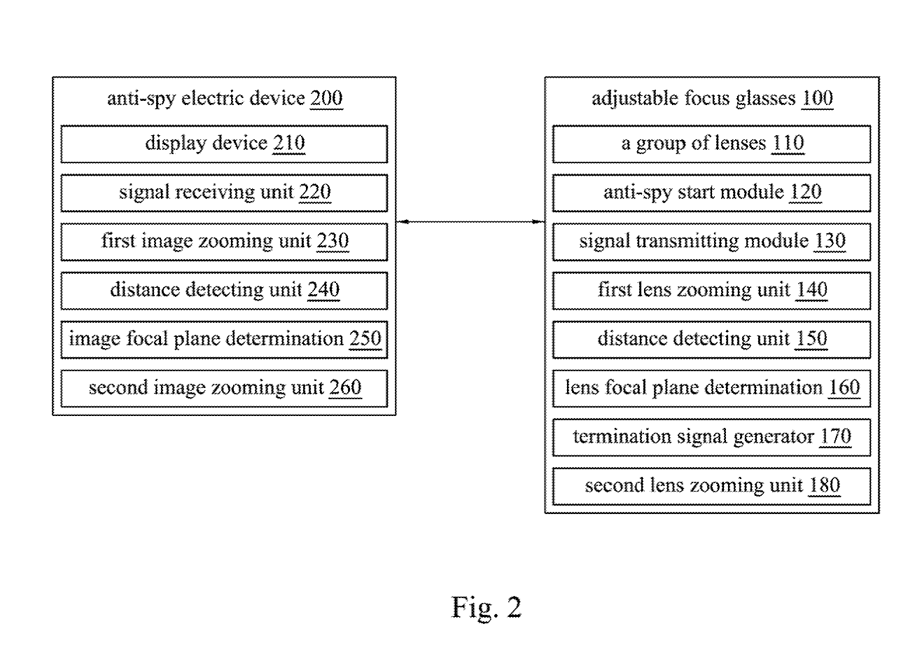

Reference is made to FIG. 1 and FIG. 2. FIG. 1 is a side view diagram of an anti-spy system for electric devices in applications in accordance with some embodiments of the present disclosure. FIG. 2 is a diagram of an anti-spy system for electric devices in accordance with some embodiments of the present disclosure. In some embodiments, an anti-spy system includes a pair of adjustable focus glasses 100 and an anti-spy electric device 200. The pair of adjustable focus glasses 100 includes a group of lenses 110, an anti-spy start module 120, a signal transmitting module 130, and a first lens zooming unit 140. The anti-spy electric device 200 includes a display device 210, a signal receiving unit 220, and a first image zooming unit 230.

More particularly in some embodiments, the group of lenses 110 of the pair of adjustable focus glasses 100 has a first lens focal plane P1. The display device 210 of the anti-spy electric device 200 is configured to display an image I on a first image focal plane I1, and the first lens focal plane P1 is substantially overlapping with the first image focal plane I1. As a result, by wearing the pair of adjustable focus glasses 100, a user may clearly observe the image I displayed on the first lens focal plane P1 (first image focal plane I1). The anti-spy start module 120 of the pair of adjustable focus glasses 100 is configured to output an anti-spy start signal S1. The signal transmitting module 130 is configured transmit the anti-spy start signal S1 to the anti-spy electric device 200. The first lens zooming unit 140 is configured to transform the first lens focal plane P1 of the group of lenses 110 into a second lens focal plane P2 depending on the anti-spy start signal S1, and the first lens focal plane P1 is not overlapping with the second lens focal plane P2. The signal receiving unit 220 of the anti-spy electric device 200 is configured to receive the anti-spy start signal S1 from the pair of adjustable focus glasses 100. The first image zooming unit 230 is configured to transform the image I displayed on the first image focal plane I1 being displayed on a second image focal plane I2 depending on the anti-spy start signal S1 from the pair of adjustable focus glasses 100, and the first image focal place I1 is non-overlapping with the second image focal plane I2. Furthermore, the second lens focal plane P2 is substantially overlapping with the second image focal plane I2 of the anti-spy electric device 200. Therefore, by wearing the pair of adjustable focus glasses 100, the user may trigger the pair of adjustable focus glasses 100 to make the anti-spy start module 120 output the anti-spy start signal S1, so the user may clearly observe the image I displayed on the second lens focal plane P2 (second image focal plane I2).

In other words, when the pair of adjustable focus glasses 100 generates the anti-spy start signal S1, the first image zooming unit 230 of the anti-spy electric device 200 may vary a focal length of the image I displayed of the anti-spy electric device 200, making the image I of the anti-spy electric device 200 focus on the second image focal plane I2. At the same time, the first lens zooming unit 140 of the pair of the adjustable focus glasses 100 may transform the first lens focal plane P1 into the second lens focal plane P2 depending on the anti-spy start signal S1. The second image focal plane I2 (that is, the second lens focal plane P2) is spaced apart from the anti-spy electric device 200 by at least one distance. As a result, by wearing the pair of the adjustable focus glasses 100, the user may receive the image I displayed on the second image focal plane I2 (that is, the second lens focal plane P2). In other words, the first lens zooming unit 140 of the pair of adjustable focus glasses 100 may clearly project the image I into two eyes of the user, and thus the user may observe the clear image. On the contrary, a viewer who is not wearing the pair of adjustable focus glasses 100 may not clearly view the blurred image, so as to improve a security of contents displayed on the anti-spy electric device 200, benefitting to protect the users privacy.

In some embodiments, for example, a first distance from the first image focal plane I1 to the anti-spy electric device 200 is less than a second distance from the second image focal plane I2 to the anti-spy electric device 200. In other words, the second image focal plane I2 is more distal to the anti-spy electric device 200 than the first image focal plane I1. For example, the first distance from the first image focal plane I1 to the anti-spy electric device 200 may substantially be 0 cm; the second distance from the second image focal plane I2 to the anti-spy electric device 200 may substantially be but not limited to be, 5 cm, 10 cm, 15 cm or 50 cm.

In some embodiments, for example, the anti-spy electric device 200 may be, but not limited to be, a laptop computer, a tablet computer, or a smartphone. In some embodiments, the anti-spy electric device 200 may further include adjustable focus optical lenses or adjustable focus films. Alternatively, in some embodiments, the anti-spy electric device 200 may further include reflective display integrated circuits to project the image of the anti-spy electric device 200, but it is not limited.

In some embodiments, the pair of adjustable focus glasses 100 may be optical lenses, optical glasses or head mounted display. In some embodiments, the pair of adjustable focus glasses 100 may be, but not limited to be, adjustable focus optical lenses or adjustable focus films. In some embodiments, the pair of adjustable focus glasses 100 may further include a button, an infrared detecting device or a pressure sensor to be an interface between the user and the anti-spy system. For example, by pressing the button of the pair of adjustable focus glasses 100, the anti-spy start module 120 may be triggered to output the anti-spy start signal S1.

In some embodiments, the anti-spy start module 120, the signal transmitting module 130 and the first lens zooming unit 140 may be integrated into one or more processing devices of the pair of adjustable focus glasses 100. The processing device may be, but not limited to be, a central processing unit, a controller, a microprocessor, a server, or any other hardware which can process instructions. In other embodiments, the anti-spy start module 120, the signal transmitting module 130 and the first lens zooming unit 140 may be executed by a computer program of an electronic device and be stored in a storage device. The storage device may include a non-transient computer readable recording medium or other device having a storage function.

In some embodiments, the display device 210, the signal receiving unit 220 and the first image zooming unit 230 may be integrated into one or more processing devices of the anti-spy electric device 200. The processing device may be, but not limited to be, a central processing unit, a controller, a microprocessor, a server, or any other hardware which can process instructions. In other embodiments, the display device 210, the signal receiving unit 220 and the first image zooming unit 230 may be executed by a computer program of an electronic device and be stored in a storage device. The storage device may include a non-transient computer readable recording medium or other device having a storage function. The computer program may include a plurality of program instructions which can be executed by a central processing unit, so as to execute the respective functions of the modules, but it is not limited.

In some embodiments, for example, the first image zooming unit 230 is realized by installing an adjustable focus software. In some embodiments, the first lens zooming unit 140 may vary an optical characteristic of the image I of the display device 210, such as a focal length, a refractive index, a scattering degree, or the like, but it is not limited. In other words, in some embodiments, the first lens zooming unit 140 may realize transforming the first lens focal plane P1 into the second lens focal plane P2 by varying the optical characteristic (such as the focal length) of the pair of adjustable focus glasses 100. However, the first image zooming unit 230 may realize transforming the first image focal plane I1 into the second image focal plane I2 by the adjustable focus software of the anti-spy electric device 200. That is, a theory for adjusting focus of the first image zooming unit 230 may be different from that of the first lens zooming unit 140, but it is not limited thereto.

In some embodiments, the anti-spy electric device 100 may further include a distance detecting unit 240 and an image focal plane determination 250. The distance detecting unit 240 is configured to detect a distance between the anti-spy electric device 200 and the pair of adjustable focus glasses 100. The image focal plane determination 250 is configured to determine a position of the second image focal plane I2 depending on the distance. More particularly, in some embodiments, the image focal plane determination 250 may be configured to assist the first image zooming unit 230 to adjust the position of the second image focal plane I2. In other words, the first image zooming unit 230 may adjust the distance from the second image focal plane I2 to the anti-spy electric device 200 depending the distance detected by the distance detecting unit 240. More particularly, when the distance detected by the distance detecting unit 240 is larger, the first image zooming unit 230 may display the image I more distally to the anti-spy electric device 200. That is, the distance from the second image focal plane I2 to the anti-spy electric device 200 may be larger. Alternatively, when the distance detected by the distance detecting unit 240 is smaller, the first image zooming unit 230 may display the image I more closely to the anti-spy electric device 200. That is, the distance from the second image focal plane I2 to the anti-spy electric device 200 may be smaller. In other words, the distance from the second image focal plane I2 to the anti-spy electric device 200 may be positively related to the distance detected by the distance detecting unit 240 from the anti-spy electric device 200 to the pair of adjustable focus glasses 100. In some embodiments, for example, the distance detecting unit 240 may determine the distance by inspecting an intensity of the received anti-spy start signal S1, but it is not limited. For example, the distance detecting unit 240 may be, but not limited to be, a ultrasonic rangefinder or a laser rangefinder.

In some embodiments, the pair of adjustable focus glasses 100 may further include a distance detecting unit 150 and a lens focal plane determination 160. The distance detecting unit 150 is configured to detect a distance between the anti-spy electric device 200 and the pair of adjustable focus glasses 100. The lens focal plane determination 160 is configured to determine a position of the second lens focal plane P2 depending on the distance. More particularly, in some embodiments, the lens focal plane determination 160 may be configured to the assist first lens zooming unit 140 to adjust the position of the second lens focal plane P2. In other words, the assist first lens zooming unit 140 may adjust the distance from the second lens focal plane P2 to the anti-spy electric device 200 depending the distance detected by the distance detecting unit 150. More particularly, when the distance detected by the distance detecting unit 150 is larger, the assist first lens zooming unit 140 may display the image I more distally to the anti-spy electric device 200. That is, the distance from the second lens focal plane P2 to the anti-spy electric device 200 may be larger. Alternatively, when the distance detected by the distance detecting unit 150 is smaller, the assist first lens zooming unit 140 may display the image I more closely to the anti-spy electric device 200. That is, the distance from the second lens focal plane P2 to the anti-spy electric device 200 may be smaller. In other words, the distance from the second lens focal plane P2 to the anti-spy electric device 200 may be positively related to the distance detected by the distance detecting unit 150 from the anti-spy electric device 200 to the pair of adjustable focus glasses 100. In some embodiments, for example, the distance detecting unit 150 may determine the distance by inspecting an intensity of the received anti-spy start signal S1, but it is not limited thereto. For example, the distance detecting unit 150 may be, but not limited to be, ultrasonic rangefinder or a laser rangefinder.

In some embodiments, the anti-spy device 200 may further include a second image zooming unit 260. The second image zooming unit 260 is configured to transform the image I displayed on the second image focal plane I2 being displayed on the first image focal plane I1 depending on an anti-spy termination signal S2 from the pair of adjustable focus glasses 100. More particularly, the pair of adjustable focus glasses 100 may also output the anti-spy termination signal S2. When the second image zooming unit 260 receives the anti-spy termination signal S2, the second image zooming unit 260 may vary the distance between the second image focal plane I2 and the anti-spy electric device 200, making the second image focal plane I2 be transformed into the first image focal plane I1. In some embodiments, for example, when the user triggers or presses a switch (not shown in the figure) of the pair of adjustable focus glasses 100 to make the pair of adjustable focus glasses 100 output the anti-spy termination signal S2, the second image zooming unit 260 may transform the second image focal plane I2 into the first image focal plane I1, so the image I of the anti-spy electric device 200 may clearly display on the first image focal plane I1 of the anti-spy electric device 200. That is, the image I may be located on the display screen of the anti-spy electric device 200.

In some embodiments, for example, the image focal plane determination 250 and the second image zooming unit 260 may be executed by a computer program of an electronic device and be stored in a storage device. The storage device may include a non-transient computer readable recording medium or other device having a storage function. The image focal plane determination 250 and the second image zooming unit 260 may be integrated into one or more processing devices of the anti-spy electric device 200. The processing device may be, but not limited to be, a central processing unit, a controller, a microprocessor, a server, or any other hardware which can process instructions.

More particularly, in some embodiments, the pair of adjustable focus glasses 100 may further include a termination signal generator 170 and a second lens zooming unit 180. The termination signal generator 170 is configured to output the anti-spy termination signal S2, and the signal transmitting module 130 is further configured to transmit the anti-spy termination signal S2 to the anti-spy electric device 200. The second lens zooming unit 180 is configured to transform the second lens focal plane P2 of the group of lenses 210 into the first lens focal plane P1 depending on the anti-spy termination signal S2. More particularly, when the user triggers or presses a switch (not shown in the figure) of the pair of adjustable focus glasses 100 to make the pair of adjustable focus glasses 100 output the anti-spy termination signal S2, second lens zooming unit 180 may transform the second lens focal plane P2 into the first lens focal plane P1, so the pair of adjustable focus glasses 100 may receive the image I displayed in the first lens focal plane P1.

In some embodiments, for example, the lens focal plane determination 160, the termination signal generator 170, and the second lens zooming unit 180 may be executed by a computer program of an electronic device and be stored in a storage device. The storage device may include a non-transient computer readable recording medium or other device having a storage function. The lens focal plane determination 160, the termination signal generator 170, and the second lens zooming unit 180 may be integrated into one or more processing devices of the anti-spy electric device 200. The processing device may be, but not limited to be, a central processing unit, controller, a microprocessor, a server, or any other hardware which can process instructions.

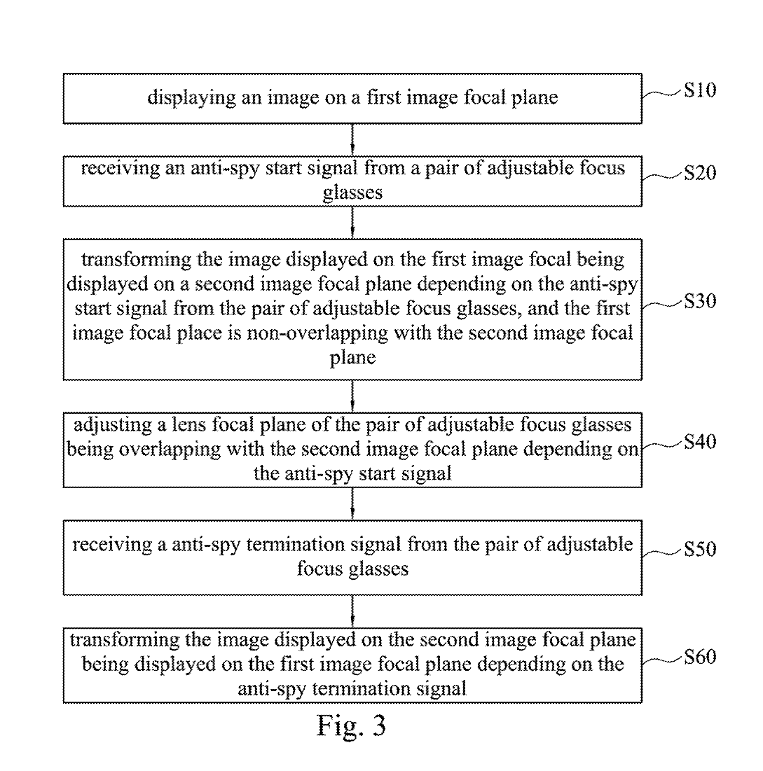

Reference is made to FIG. 3. FIG. 3 is a flow chart of an anti-spy method for electric devices in accordance with some embodiments of the present disclosure. In some embodiments an anti-spy method includes following steps. In step S10, displaying the image I on the first image focal plane I1. In step S20, receiving the anti-spy start signal S1 from the pair of adjustable focus glasses 100. In step S30, transforming the image I displayed on the first image focal I1 being displayed on the second image focal plane I2 depending on the anti-spy start signal S1 from the pair of adjustable focus glasses, and the first image focal place is non-overlapping with the second image focal plane. In step S40, adjusting a lens focal plane of the pair of adjustable focus glasses 100 being overlapping with the second image focal plane I2 depending on the anti-spy start signal S1. In step S50, receiving the anti-spy termination signal S2 from the pair of adjustable focus glasses 100. In step S60, transforming the image I displayed on the second image focal plane I2 being displayed on the first image focal plane I1 depending on the anti-spy termination signal S2.

More particularly, in some embodiments, the step S30 further includes following steps. In step 32, detecting the distance between the anti-spy electric device 200 and the pair of adjustable focus glasses 100. In step S34, determining a position of the second age focal plane I2 depending on the distance.

As a result, by such configuration of the pair of adjustable focus glasses 100 and the anti-spy electric device 200, the anti-spy electric device 200 may transform the image I displayed from the first image focal plane I1 (that is, the first lens focal plane P1) to the second image focal plane I2 (that is, the second lens focal plane P2). In other words, the anti-spy electric device 200 may vary the focal length of the image I, making the image I of the anti-spy electric device 200 focus on the second image focal plane I2. At the same time, the first lens zooming unit 140 of the pair of the adjustable focus glasses 100 may transform the first lens focal plane P1 into the second lens focal plane P2 depending on the anti-spy start signal S1, so the image I displayed on the second image focal plane I2 (that is, the second lens focal plane P2) may be projected into a target positon (two eyes of the user). Therefore, the user wearing the pair of adjustable focus glasses 100 may clearly observe the image. A viewer without the target positon may observe a blurred image, so as to improve the security of contents displayed on the anti-spy electric device 200, with a benefit of protecting the user's privacy.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An anti-spy electric device, comprising:
a display device configured to display an image on a first rage focal plane;
a signal receiving unit configured to receive an anti-spy start signal from a pair of adjustable focus glasses; and
a first image zooming unit configured to transform the image displayed on the fiat image focal plane being displayed on a second image focal plane depending on the anti-spy start signal from the pair of adjustable focus glasses, wherein the first image focal place is non-overlapping with the second image focal plane.

2. The anti-spy electric device of claim 1, further comprising:
a distance detecting unit configured to detect a distance between the anti-spy electric device and the pair of adjustable focus glasses; and
an image focal plane determination configured to determine a position of the second image focal plane depending on the distance.

3. The anti-spy electric device of claim 1, further comprising:
a second image zooming unit configured to transform the image displayed on the second image focal plane being displayed on the first image focal plane depending on an anti-spy termination signal from the pair of adjustable focus glasses.

4. A pair of adjustable focus glasses, comprising:
a group of lenses having a first lens focal plane;
an anti-spy start module configured to output an anti-spy start signal;
a signal transmitting module configured to transmit the anti-spy start signal to an anti-spy electric device; and
a first lens zooming unit configured to transform the first lens focal plane of the group of lenses into a second lens focal plane depending on the anti-spy start signal, wherein the first lens focal plane is not overlapping with the second lens focal plane.

5. The pair of adjustable focus glasses of claim 4, further comprising:
a distance detecting unit configured to detect a distance between the anti-spy electric device and the pair of adjustable focus glasses; and
a lens focal plane determination configured to determine a position of the second lens focal plane depending on the distance.

6. The pair of adjustable focus glasses of claim 4, further comprising:
a termination signal generator configured to output an anti-spy termination signal, wherein the signal transmitting module is further configured to transmit the anti-spy termination signal to the anti-spy electric device; and
a second lens zooming unit configured to transform the second lens focal plane of the group of lenses into the first lens focal plane depending on the anti-spy termination signal.

7. An anti-spy method for an electric device, comprising:
displaying a image on a first image focal plane;
receiving an anti-spy start signal from a pair of adjustable focus glasses; and
transforming the image displayed on the first image focal being displayed on a second image focal plane depending on the anti-spy start signal from the pair of adjustable focus glasses, wherein the first image focal place is not overlapping with the second image focal plane.

8. The anti-spy method of claim 7, further comprising:
detecting a distance between the anti-spy electric device and the pair of adjustable focus glasses; and
determining a position of the second image focal plane depending on the distance.

9. The anti-spy method of claim 7, further comprising:
receiving an anti-spy termination signal from the pair of adjustable focus glasses; and
transforming the image displayed on the second image focal plane being displayed on the first image focal plane depending on the anti-spy termination signal.

10. The anti-spy method of claim 7, further comprising:
adjusting a lens focal plane of the pair of adjustable focus glasses being overlapping with the second image focal plane depending on the anti-spy start signal.
